(19) United States
(12) Patent Application Publication
(10) Pub. No.: US 2007/0262180 A1
(43) Pub. Date: Nov. 15, 2007

(54) Vehicle engine-driven pressure-washing system and method

(76) Inventor: John R. Adams, Oregon, WI (US)

Correspondence Address: KLARQUIST SPARKMAN, LLP, 121 SW SALMON STREET, SUITE 1600, PORTLAND, OR, 97204, US

(21) Appl. No.: 11/434,424

(22) Filed: May 12, 2006

(51) Int. Cl. B08B 3/00; B08B 3/12; B05B 3/00

(52) U.S. Cl. 239/738; 134/198; 134/172; 134/34; 134/105

(57) ABSTRACT

Mobile pressure-washing systems are disclosed that can be coupled to a carrier vehicle's engine for receiving operational power and heat power from the engine. The system includes a pump that is driven by a driven member of the engine. The system captures heat from the engine, particularly while the engine is running, such as from liquid coolant used for cooling the engine and/or from hot exhaust gases produced by the running engine. The carrier vehicle can include a utility bay including hydraulic fittings connected to the pump and heat exchanger and connectable to a supply of pressure-washing liquid and to a conduit used for discharging the stream of heated and pressurized liquid. The supply can be a tank carried on the vehicle.

### FIELD

This disclosure relates to powered pressure-washing systems as used, for example, for commercial and industrial cleaning applications.

### BACKGROUND

A variety of pressure-washing systems are available to consumers and professionals for light-duty and household cleaning work. Most of these systems are relatively light in weight and are highly portable (movable about by hand). Although these light-weight “household” units are powered by dedicated gasoline or electrical motors, the size of the motor and pumping power deliverable by the motor are necessarily severely limited in the interest of keeping the systems highly portable.

Heavy-duty, industrial cleaning work typically requires pressure-washing systems having more capacity and power than can be produced by the typical household unit. To address these requirements, the industry has developed larger and more powerful pressure-washing systems that are still self-contained (powered by their own dedicated motors). However, due to their size and mass (and also the size and mass of any fuel tank associated with them), these systems are less conveniently portable and must be conveyed about on a large carrier vehicle such as a trailer, truck, or van. Another disadvantage of these systems is that they are still limited in the amount of power they can develop. For example, with gasoline-powered systems, the engine powering the system is often of a small, single- or twin-cylinder configuration such as may be found on a riding lawnmower. The smaller size of such an engine results in limited available power for driving the pump producing the pressurized flow of liquid from the pressure-washing system. Increasing the size of the motor to obtain more power adds further substantial mass to the system, making the system even less portable.

A few pressure-washing systems are available that are mounted directly to a carrier vehicle (truck or van) and obtain power from the carrier-vehicle's engine. Driving power for the pressure-washing system is obtained from the vehicle's engine by a complex modification of the vehicle and engine. Specifically, the engine is permanently modified to include a power take-off (PTO) such as provided on a farm tractor's engine. A shaft is extended from the PTO through the floor of the carrier vehicle and connected to a high-pressure liquid pump usually located inside but in the rear of the carrier vehicle. The PTO mechanism and connecting shaft adds substantial complexity and mass, requiring that the carrier vehicle be even larger, more powerful, and more massive.

Heating a high-pressure liquid as delivered from a pressure-washing system can increase the cleaning efficiency and effectiveness of the liquid. Usually, heat is generated by an integrated or stand-alone burner unit that burns diesel, kerosene, propane, or other suitable fuel. Heat from the burning fuel is delivered to the pressurized liquid, usually by passing the hot combustion gases and the pressurized liquid through a heat-exchanger. Unfortunately, it is very difficult to accommodate a burner unit safely and conveniently on a carrier vehicle, especially in any manner in which the burner unit (and pressure-washing system) is enclosed in the carrier vehicle.

### SUMMARY

Pressure-washing systems are disclosed that are mounted to, and that obtain operating power from, a motor vehicle (called a “carrier” vehicle or “host vehicle”). Specifically, the pressure-washing systems are configured to derive operational power (pumping power) from the engine of the carrier vehicle and are also configured to extract heat from the engine for heating liquid for discharge by the pressure-washing system. The pressure-washing systems are sufficiently compact and efficient to be installed in any of various motor vehicles, including motor vehicles regarded as “compact” and “sub-compact” in size. Thus, the subject pressure-washing systems can be conveyed to a remote job site by a small, fuel-efficient vehicle, in contrast to having to use a large van, truck, or trailer to transport the system.

An aspect of the disclosure is directed to mobile pressure-washing systems. A representative embodiment of such a system comprises a vehicle including an engine that is configured and used, when the engine is running, for propelling the vehicle. The engine comprises a driven member and produces heat when running. The system includes a pump that is in proximal relation to the engine and that is operably coupled to the driven member of the engine such that the driven member of the running engine operates the pump for pumping and pressurizing a pressure-washing liquid. A first hydraulic conduit connects an inlet of the pump to a source of the pressure-washing liquid. The system also includes a heat-exchanger that is coupled to the engine so as to obtain heat from the engine for transfer to the pressure-washing liquid. The heat-exchanger is hydraulically coupled to the pump such that the pump and heat-exchanger cooperatively produce pressurized heated liquid. The system also includes a discharge outlet that is hydraulically coupled to receive the pressurized heated liquid from the pump and heat-exchanger and to discharge the pressurized heated liquid for cleaning purposes.

The pump can be any commercially available pump device capable of urging pressurized flow of a liquid at a desired operating pressure and flow rate, while being powered by a vehicle engine. The pump is situated proximally to the engine and can be mounted to the engine. A mounting plate can be used to facilitate such mounting. Alternatively, for example, the pump can be mounted on a structure separate from but near the engine. The pump can be coupled to the driven member via at least one pulley and drive belt. Exemplary alternative coupling schemes include, but are not limited to, toothed gears and drive chain, and gear trains. Yet another coupling scheme is connection to a turbine that is rotated by the pressure of exhaust gases produced by the engine.

The heat-exchanger can be hydraulically coupled downstream of the pump so as to receive pressurized liquid from the pump. In such a scheme, the pump can be configured to pump only non-heated liquid.

If the engine includes a liquid-cooling system comprising a radiator connected to receive and cool hot coolant circulated through the engine, the heat-exchanger can be hydraulically coupled to receive the hot coolant from the engine and to transfer heat from the hot coolant to the pressure-washing liquid. In such a system the heat-exchanger can be hydraulically coupled to receive hot coolant from the engine and to deliver heat-exchanged coolant to the radiator.

The engine typically includes an exhaust conduit that conducts hot exhaust gases as the engine is running. In addition to the heat-exchanger configuration summarized above, the system can comprise a second heat-exchanger connected to the exhaust conduit so as to receive the hot exhaust gases and to transfer heat from the hot exhaust gases to the pressure-washing fluid. The heat-exchangers can be hydraulically connected to each other such that pressure-washing fluid flows through and obtains heat from both heat-exchangers before being discharged for pressure-washing purposes.

As an alternative to embodiments including two heat-exchangers, the system can include one heat-exchanger that is connected to the exhaust conduit of the engine so as to receive hot exhaust gases from the engine and to transfer heat from the hot exhaust gases to the pressure-washing fluid.

The heat-exchanger(s), by extracting and using waste heat produced by the engine, eliminate a need (under most situations) for a separate burner (requiring a separate fuel source) for heating the liquid.

The system can further comprise a selectively actuatable clutch coupling the driven member to the pump. The clutch can be, for example, a magnetic clutch, an electric clutch, or an electromagnetic clutch. A remote switch can be provided in a location convenient for the operator when turning the system on and off. I.e., the clutch allows the cleaning system to be engaged, and thus operated, only when use of the pressure-washing system is desired. Thus, the clutch can preserve pump longevity and conserve engine power, particularly when the vehicle and its engine are small.

The system can further comprise first and second hydraulic couplings, wherein the first hydraulic coupling is connected to the input of the pump and is connectable to a source of the pressure-washing liquid, and the second hydraulic coupling is connected to the discharge outlet. The first and second hydraulic couplings can be located in a utility bay of the carrier vehicle. The utility bay can be located, for example, in the trunk of the vehicle or, if the vehicle is a truck, in the bed of the truck. The utility bay can include a control used by the operator for engaging and disengaging the clutch.

Thus, lightweight, efficient, and easily transported pressure-washing systems are provided. The systems are easily adapted for use on smaller vehicles, such as compact passenger cars, allowing for better fuel efficiency and lower costs to the user.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic view of a representative embodiment of a pressure-washing system as installed on a vehicle.

FIG. 2 is a perspective view of the pump and heat-exchanger of the FIG. 1 embodiment as installed on a vehicle's engine.

FIG. 3 is a sectional view of an embodiment of a secondary heat-exchanger configured to be installed in the exhaust pipe of the vehicle's engine.

### DETAILED DESCRIPTION

The disclosure below is directed to a representative embodiment that is not intended to be limiting in any way.

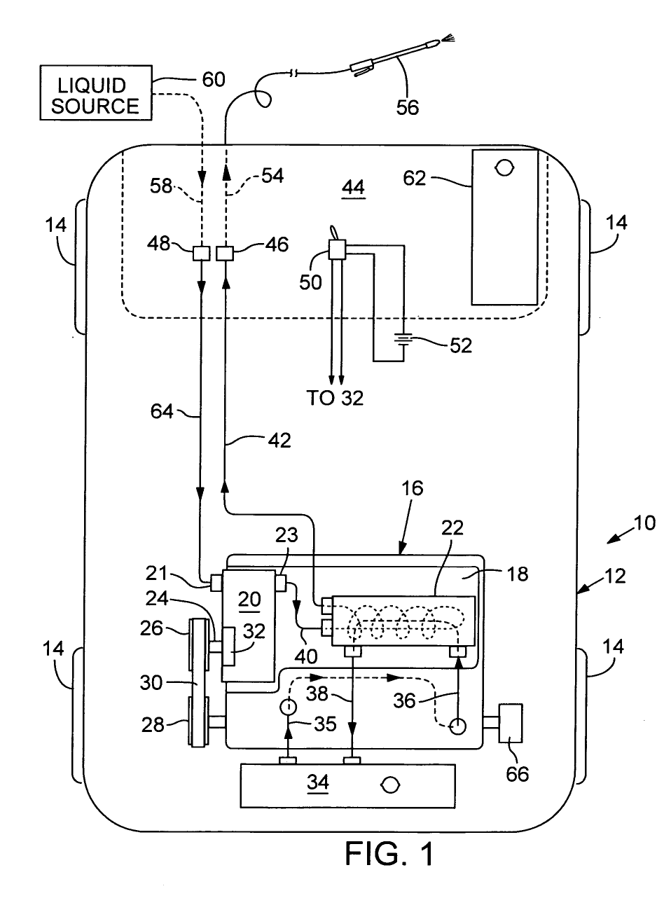

Turning first to FIG. 1, a representative embodiment of a vehicle-mounted pressure-washing system 10 is shown. The system comprises a vehicle 12 (also called a “carrier vehicle” and a “host vehicle”) with wheels 14 and an engine 16 used for turning the wheels and propelling the vehicle. Mounted to the engine 16 (e.g., on or at an upper surface of the engine, for convenience) is a mounting plate 18 to which a pump 20 and heat-exchanger 22 are mounted. The mounting plate 18 can be shaped and configured, relative to the profile of the engine 16, to allow ready access to portions of the engine that may require service (e.g., checking engine oil level, oil-filling, and other routine engine-service tasks), without having to remove the mounting plate. The mounting plate 18 can be mounted to the engine 16 in a manner allowing for easy removal of the mounting plate from the engine, if necessary. For example, the mounting plate 18 can be mounted to the engine using one or more bolts (not shown in FIG. 1, which can be of a hand-removable type, such as wing-headed bolts). As an alternative to bolts, any of various clips and the like can be used for attaching the mounting plate 18 to the engine 16.

Alternatively to attaching the mounting plate 18 directly to the engine 16, the mounting plate can be mounted in the engine compartment of the vehicle 12 so as to be in proximal relationship to the engine as if the mounting plate were mounted to the engine. Since the mounting plate 18 in this embodiment provides a mounting for the pump 20 and heat-exchanger 22, a “proximal relationship” of the mounting plate to the engine is any position of the mounting plate allowing power transfer from the engine to the pump, as described below.

Further alternatively, the mounting plate 18 can be eliminated and the pump 20 (and heat-exchanger 22) mounted in the engine compartment of the vehicle 12 or in any other manner that places the pump 20 in proximal relationship to the engine. For example, the pump 20 and heat-exchanger 22 can be mounted on the side of the engine bay or on the “firewall” of the engine compartment of the vehicle if space permits.

The pump 20 can be any of various suitable hydraulic pumps as known in the art for use in pressure-washing applications. For example, the pump 20 can be any of various configurations as used on portable, stand-alone pressure-washing systems. The pump 20 is selected based on the particular cleaning applications for which the system 10 will be used, the particular compatibility of the pump with the power capabilities of the engine 16, and the available space in the vicinity of the engine where the pump can be mounted. The pump 20 includes an inlet 21 and an outlet 23.

In the depicted embodiment, the pump 20 comprises a shaft 24 to which is attached a pulley 26. An accessory pulley 28 is mounted to the engine 16, for example, tandemly to a fan-pulley or other driven-pulley of the engine. A drive belt 30 is mounted to the pulleys 26, 28 such that, as the accessory pulley 28 is rotated by running of the engine 16, corresponding rotational motion is imparted to the pulley 26 of the pump. Thus, the pump 20 is operably coupled to the engine 16. As an alternative with certain engine configurations, it is possible to couple the shaft 24 of the pump 20 directly to a “driven member” of the engine, such as but not limited to the shaft to which the accessory pulley 28 is connected. (As used herein, a “driven member” is a portion of the engine 16 that undergoes motion, usually rotational motion, whenever the engine is running.) As another alternative, the shaft 24 can be coupled to a driven member using one or more gears, as in a gear train, or using a combination of gears and pulleys, for example. As yet another alternative (not shown), the engine 16 can include a turbine or analogous device, as a “driven member,” wherein the turbine is rotated by flow of exhaust gases from the engine, and the turbine is operably coupled (e.g., by a gear train or the like, if required) to the shaft 24.

The drive belt 30 in the depicted embodiment is not limited to a reinforced elastomeric “belt” as commonly used with pulleys in engines; in certain embodiments the drive belt can be a chain belt or the like that is used with pulleys provided with drive teeth around their circumference.

Either the pulley 26 or the shaft 24 includes a clutch 32 that can be turned on and off to effect engagement and disengagement, respectively, of pump operation from the running of the engine 16. By way of example, the clutch 32 can be an electrically or magnetically engageable type similar to clutches used on automotive air-conditioning compressors. By de-actuating the clutch 32, an operator selectably disengages the delivery of drive force from the engine 16 to the pump 20 whenever the pressure-washing system 10 is not in use, thereby preventing unnecessary wear on the pump 20. Actuation of the clutch 32 causes delivery of drive force from the engine 16 to the pump 20 during running of the engine and use of the pump for pressure-washing.

In FIG. 1 the heat-exchanger 22 is mounted to the mounting plate 18. (Alternatively, for example, the heat-exchanger 22 can be mounted elsewhere in the engine compartment of the vehicle.) The heat-exchanger 22 is hydraulically coupled in-line with the cooling system of the engine 16. For example, if the engine 16 is liquid-cooled, it typically has a radiator 34 through which liquid coolant from the engine is circulated. With such an engine, the heat-exchanger 22 can be connected in series with, and hydraulically upstream of, the radiator 34 by conduits 36, 38 (e.g., flexible hoses). A conduit 35 (e.g., flexible hose) connects the output of the radiator 34 to the engine 16 in the normal manner. The pump 20 is connected to the heat-exchanger 22 by a conduit 40 (e.g., a flexible hose).

Liquid to be pressurized for pressure-washing purposes enters the pump 20 via the inlet 21, which conducts the liquid from a source 60, described later below. As the pump operates, it pressurizes the liquid and expels the pressurized liquid via the outlet 23. As engine coolant is circulated through the heat-exchanger 22, pressurized liquid from the outlet 23 circulates through the heat-exchanger, where the pressurized liquid obtains heat from the engine coolant by thermal exchange. The heat-exchanger 22 can be any of various commercially available heat-exchanging units selected based on its compatibility with the particular cooling system of the vehicle's engine 16 (e.g., liquid-cooled or air-cooled) and on its compatibility with the operating pressures developed by the pump 20.

Although, in this embodiment, the heat-exchanger 22 is hydraulically coupled downstream of the pump 20, other embodiments are possible in which the heat-exchanger is coupled upstream of the pump.

From the heat-exchanger 22, the heated, pressurized liquid is delivered via a conduit 42 (e.g., a flexible hose capable of withstanding the heat and pressure of the liquid) to a utility bay 44 or other convenient location on the vehicle 12. For example, the utility bay 44 can be the trunk of the vehicle 12 or other compartment or region dedicated to use for pressure washing and, desirably, sufficiently commodious for storing hoses and other implements used in pressure-washing.

The utility bay 44 includes hydraulic couplings 46, 48 and a control switch 50. The control switch 50 is electrically connected to a battery 52 or other convenient power supply (e.g., the vehicle's battery) and to the clutch 32. Thus, by manipulating the control switch 50, an operator can selectively turn the clutch 32 on and off as desired. Turning on the clutch 32 as the engine 16 is running effectively turns on the pressure-washing system. The hydraulic coupling 46 is connected to the conduit 42 from the heat-exchanger 22. At the hydraulic coupling 46, an operator can connect (via a conduit 54 such as a reinforced rubber hose) a pressure-washing wand 56 or the like as known in the art. For this purpose, the hydraulic coupling 46 desirably has a “quick-release” configuration to allow ready connection and disconnection from the conduit 54 as desired. Furthermore, the hydraulic coupling 46 desirably prevents, when disconnected from the conduit 54, liquid from draining from the conduit 42. In any event, the hydraulic coupling 46 and conduit 54 allow delivery of heated, pressurized liquid from the heat-exchanger 22 to a location remote from the vehicle 12 for use in pressure-washing.

The hydraulic coupling 48 is connectable to a conduit 58 (e.g., a reinforced rubber hose) that supplies water or other suitable liquid to the pressure-washing system. The hydraulic coupling 48 desirably is a “quick-release” type of coupling, similar to the hydraulic coupling 46, described above. The conduit 58 is configured to connect to the particular type of liquid source 60 normally used, such as a water spigot at the job site.

The water spigot can be, for example, connected to a municipal water supply at the job site or connected to a tank of liquid situated at the job site. Alternatively, the conduit 58 can be connected to a liquid tank 62 carried on the vehicle 12. Thus, the supplied liquid is delivered via the conduit 58 and via a conduit 64 (extending from the hydraulic coupling 48 to the pump 20) to the pump 20. As the liquid passes through the pump 20, the liquid is pressurized for delivery to the heat-exchanger 22 and ultimately to the wand 56.

As can be appreciated from the foregoing, operation of the pressure-washing system requires that the vehicle's engine 16 be running. Adequate heating of the liquid would be best achieved if the engine were operating at its normal equilibrium running temperature. If desired, the engine 16 can be provided with a throttle 66 for regulating the operational speed of the engine during times when the pressure-washing system is in use. Normally, during use of the pressure-washing system, the engine is not being used for propelling the vehicle, but situations are envisioned in which pressure-washing could be performed as the vehicle is moving.

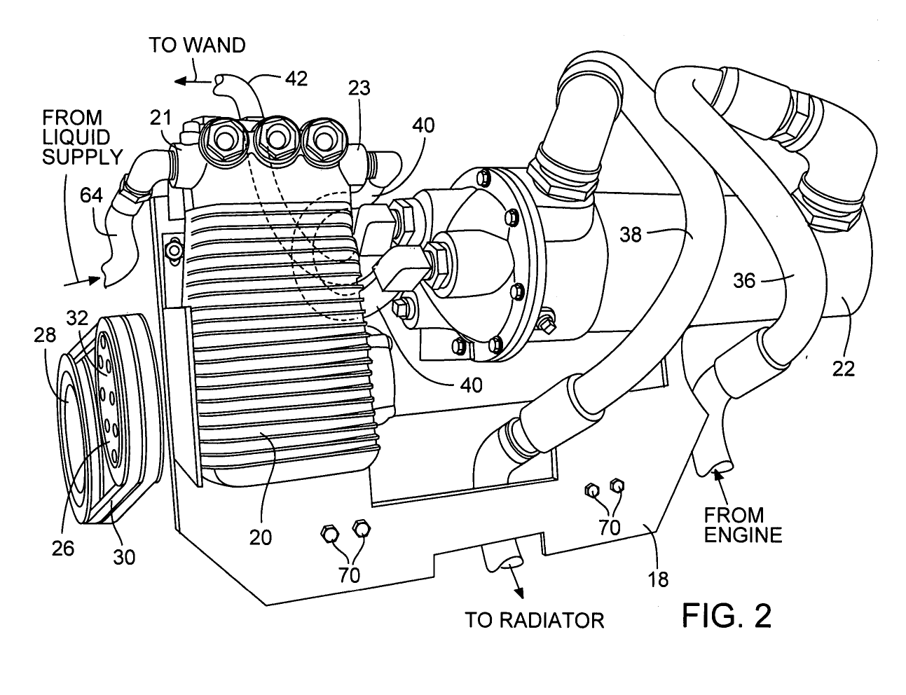

Turning now to FIG. 2, certain details of an exemplary mounting of the pump 20 and heat-exchanger 22 on the vehicle engine are shown. As noted, the mounting plate 18 can be affixed to the top of the engine using machine bolts 70, and the pump 20 and heat-exchanger 22 are mounted to the plate 18. As suggested in the figure, the mounting plate 18 desirably is sized and configured so as to pose a minimal obstruction to tasks normally performed during routine engine servicing, such as checking of fluid levels and adding oil, without having to remove the plate 18. As noted earlier above, to provide convenience in situations in which the engine may require more extensive service, as an alternative to machine bolts, the plate 18 can be attached to the engine using manually turnable bolts or any of various clips and the like. Thus, the plate 18 is easily detached and reattached to the engine as conditions dictate.

Further with respect to FIG. 2, the pulleys 26, 28 and drive belt 30 are shown. The accessory pulley 28 is mounted to the engine and is rotationally coupled to the pulley 26 of the pump 20 by the drive belt 30. Associated with the pulley 26 is the clutch 32 (e.g., magnetic, electric, electromagnetic, or hydraulic) allowing the pump 20 to be disengaged whenever the pressure-washing system is not in service. The heat-exchanger 22 in this embodiment is mounted proximally to the pump 20 for thermal efficiency, and is connected in-line with the liquid-cooling system (specifically the radiator 34) of the engine by the conduits 36, 38. Hot liquid from the engine block flows through the conduit 36, through the heat-exchanger 22, and then through the conduit 38 to the radiator 34. The conduits 36, 38 connecting the heat-exchanger 22 to the cooling system of vehicle engine 16 are of a type capable of withstanding the pressures and temperatures typically encountered in a vehicle-cooling system, such as flexible radiator hoses known in the art.

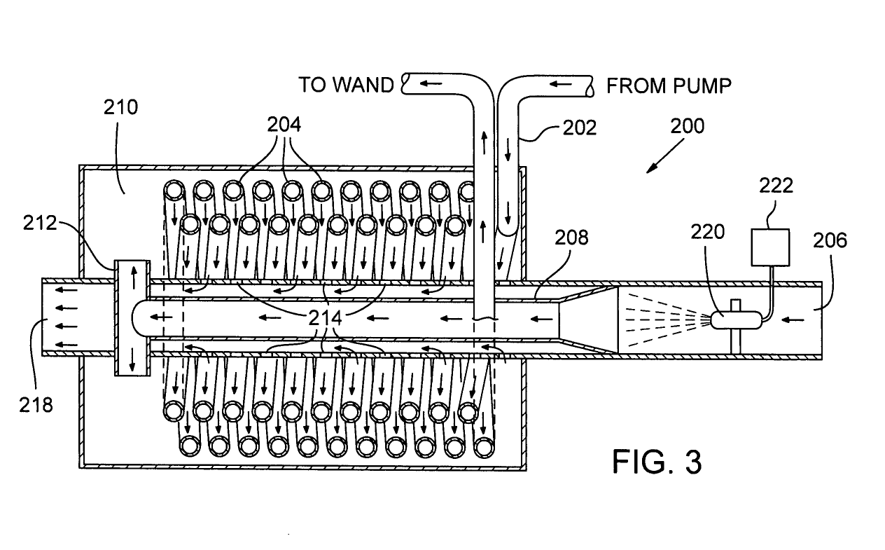

As an alternative to the pump 20 being powered by the engine 16 of the vehicle 12, it is possible to power the pump using an electric motor powered by the electrical system of the vehicle. Such an electrical system typically would include the battery 52 and an alternator (not shown, but well-known in the motor-vehicle art) for charging the battery as the engine 16 is running.

Whereas FIGS. 1 and 2 depict a heat-exchanger 22 that is connected to the cooling system of a vehicle engine, it is possible to utilize a heat-exchanger that exchanges heat with the hot gases exiting the engine 16 via the exhaust system of the engine. An exemplary embodiment of such a heat-exchanger 200 is shown in FIG. 3. The depicted heat-exchanger 200 is configured specifically for installation in-line with the exhaust system 202 of the engine 20 (engine not shown in FIG. 3). The exhaust system 202 is a good source of a substantial amount of waste heat that can be captured using a heat-exchanger, and can provide sufficient energy to heat the pressurized liquid for the pressure-washing system to a temperature of over 240° F. The heat-exchanger 200 can be used alone or in conjunction with the heat-exchanger 22, described above, that is connected to the cooling system of the engine.

Using both heat-exchangers 22, 200 can be very effective in providing hot, pressurized liquid for pressure-washing when, for example, the liquid temperature obtainable using the heat-exchanger 22 alone is insufficient for the task at hand. In this exemplary embodiment pressurized liquid flowing in the conduit 42 from the heat-exchanger 22 (used as a “primary” heat-exchanger; see FIG. 1) is diverted via a conduit 202 into heating coils 204 of the heat-exchanger 200 (used as a “secondary” heat-exchanger; see FIG. 3). Meanwhile, hot exhaust gases from the engine 16 enter the secondary heat-exchanger 200 via an inlet 206 that is connected directly to the exhaust pipe (not shown) of the engine 16. The hot gases then pass through an inner pipe 208 and enter the body 210 of the secondary heat-exchanger via a T-fitting 212. As the gases flow through the body 210, they flow past and around the heating coils 204, where the heat energy of the hot gases is transferred to the liquid passing through the heating coils 204. The exhaust gases re-enter the engine's exhaust pipe via perforations 214, and exit the secondary heat-exchanger 200 via an outlet 218.

If even more heat is needed than can be supplied by the hot exhaust gases from the engine, a burner 220 can be installed at a location inside the inlet 206, for example. The burner 220 is connected to, and configured to combust fuel supplied by, an external source 222 such as a propane source. Hot gases produced by the burner 222 combined with the hot exhaust gases from the engine 16 provide a large amount of heat that can be exchanged with the liquid flowing through the heating coils 204.

In an alternative configuration of the secondary heat-exchanger 200, the hot exhaust gases from the engine 16 simply pass straight through a chamber containing the heat-exchange coils 204. Such a configuration would likely pose a lower back-pressure to the flow of exhaust from the engine to the external environment than the configuration shown in FIG. 3, but may be less thermally efficient than the FIG. 3 embodiment.

Whereas the invention is described above in connection with several representative embodiments, it is not limited to those embodiments. On the contrary, the invention is intended to encompass all modifications, alternatives, and equivalents as may be within the spirit and scope of the invention, as set forth in the appended claims.

What is claimed is:

1. A mobile pressure-washing system, comprising:
a vehicle including an engine configured and used, when the engine is running, for propelling the vehicle, the engine comprising a driven member and producing heat when running;
a pump in proximal relation to the engine and operably coupled to the driven member of the engine such that the driven member of the running engine operates the pump for pumping and pressurizing a pressure-washing liquid, the pump having an inlet;
a first hydraulic conduit connecting the inlet of the pump to a source of the pressure-washing liquid;
a heat-exchanger coupled to the engine so as to obtain heat from the engine for transfer to the pressure-washing liquid, the heat-exchanger being hydraulically coupled to the pump such that the pump and heat-exchanger cooperatively produce pressurized heated liquid; and
a discharge outlet hydraulically coupled to receive the pressurized heated liquid from the pump and heat-exchanger and to discharge the pressurized heated liquid for cleaning purposes.

2. The system of claim 1, wherein the pump is mounted to the engine.

3. The system of claim 1, wherein the heat-exchanger is hydraulically coupled downstream of the pump so as to receive pressurized liquid from the pump.

4. The system of claim 1, wherein the pump is coupled to the driven member via at least one pulley and drive belt.

5. The system of claim 1, wherein:
the engine further comprises a liquid-cooling system comprising a radiator connected to receive and cool hot coolant circulated through the engine; and
the heat-exchanger is hydraulically coupled to receive the hot coolant from the engine and to transfer heat from the hot coolant to the pressure-washing liquid.

6. The system of claim 5, wherein the heat-exchanger is hydraulically coupled to receive hot coolant from the engine and to deliver heat-exchanged coolant to the radiator.

7. The system of claim 5, wherein:
the engine includes an exhaust conduit that conducts hot exhaust gases as the engine is running;
the system further comprises a second heat-exchanger connected to the exhaust conduit so as to receive the hot exhaust gases and to transfer heat from the hot exhaust gases to the pressure-washing fluid; and
the heat-exchangers are hydraulically connected to each other such that pressure-washing fluid flows through and obtains heat from both heat-exchangers before being discharged for pressure-washing purposes.

8. The system of claim 1, wherein:
the engine includes an exhaust conduit that conducts hot exhaust gases as the engine is running; and
the heat-exchanger is connected to the exhaust conduit so as to receive the hot exhaust gases and to transfer heat from the hot exhaust gases to the pressure-washing fluid.

9. The system of claim 1, further comprising a selectively actuatable clutch coupling the driven member to the pump.

10. The system of claim 1, further comprising first and second hydraulic couplings, wherein:
the first hydraulic coupling is connected to the input of the pump and is connectable to a source of the pressure-washing liquid; and
the second hydraulic coupling is connected to the discharge outlet.

11. The system of claim 10, further comprising a utility bay including the first and second hydraulic couplings.

12. A pressure-washing system for attachment to a motor vehicle propelled by a heat-generating engine having a driven member, the system comprising:
a pump situated in proximal relationship to the engine and operably connectable to the driven member of the engine such that the driven member of the running engine operates the pump for pumping and pressurizing a pressure-washing liquid, the pump having an input that is hydraulically connectable to a source of the pressure-washing liquid;
a heat-exchanger connectable to the engine so as to obtain heat from the engine for transfer to the pressure-washing liquid, the heat-exchanger being hydraulically coupled to the pump such that the pump and heat-exchanger cooperatively produce pressurized heated liquid; and
a discharge outlet hydraulically coupled to receive the pressurized heated liquid from the pump and heat-exchanger and to discharge the pressurized heated liquid for cleaning purposes.

13. The system of claim 12, further comprising a mounting plate by which at least one of the pump and heat-exchanger is mountable to the engine.

14. A pressure-washing system, comprising:
vehicle means;
engine means for propelling the vehicle means;
heat-generating means associated with the engine means;
pump means for pumping and pressurizing a pressure-washing liquid;
drive means for coupling the pump means to the engine means in a manner that obtains pump-driving power for the pump means from the engine means; and
first heat-exchange means for obtaining heat from the heat-generating means and for transferring at least a portion of the heat to the pressure-washing liquid to produce a stream of pressurized, heated pressure-washing liquid.

15. The system of claim 14, wherein:
the heat-generating means heats an engine liquid coolant;
the engine means further comprises engine-cooling means for circulating the engine liquid coolant and for cooling the engine liquid coolant; and
the first heat-exchange means receives higher temperature liquid coolant from the engine-cooling means, and transfers heat from the higher temperature liquid coolant to the pressure-washing liquid.

16. The system of claim 14, wherein:
the heat-generating means produces a stream of hot exhaust gases from the engine; and
the first heat-exchange means receives the hot exhaust gases and transfers heat from the hot exhaust gases to the pressure-washing liquid.

17. The system of claim 16, further comprising burner means for further heating of the exhaust gases before the first heat-exchange means transfers heat from the exhaust gases to the pressure-washing liquid.

18. The system of claim 16, further comprising second heat-exchange means, wherein:
the heat-generating means further heats an engine liquid coolant;
the engine means further comprises engine-cooling means for circulating the engine liquid coolant and for cooling the engine liquid coolant; and
the second heat-exchange means receives higher temperature liquid coolant from the engine-cooling means, and transfers heat from the higher temperature liquid coolant to the pressure-washing liquid so as, in cooperation with the first heat-exchange means, to heat the pressure-washing liquid.

19. The system of claim 18, wherein the first heat-exchange means receives heated pressure-washing liquid from the second heat-exchange means.

20. The system of claim 14, wherein the drive means comprises pulley-and-drive-belt means for coupling the pump means to the engine means.

21. The system of claim 14, wherein said drive means further comprises clutch means for providing selective coupling of the drive means between the engine means and the pump means.

22. A method for producing a stream of pressurized and heated pressure-washing liquid at a desired location, the method comprising:
placing a motor vehicle at the location, the motor vehicle having an engine that propels the vehicle and produces heat;
coupling a pump to the engine so as to drive the pump in a manner causing the pump to produce a pumping force;
routing a stream of pressure-washing liquid to the pump and allowing the pump to apply the pumping force to the stream;
capturing heat from the engine and transferring the heat to the stream of pressure-washing liquid; and
discharging the pressurized stream of heated pressure-washing liquid at the location.

23. The method of claim 22, wherein the heat-capturing step comprises capturing heat from liquid coolant used for cooling the engine.

24. The method of claim 22, wherein the heat-capturing step comprises capturing heat from hot exhaust gases produced by the engine.

25. The method of claim 24, wherein the heat-capturing step further comprises capturing heat from liquid coolant used for cooling the engine.

26. The method of claim 22, wherein the step of coupling a pump to the engine comprises coupling a driven member of the engine to the pump so that rotation of the driven member actuates the pump.

27. The method of claim 22, wherein the step of routing a stream of pressure-washing liquid to the pump comprises providing the stream from a tank of the pressure-washing liquid carried on the motor vehicle.
